(19) United States
(12) Patent Application Publication
(10) Pub. No.: US 2010/0005915 A1
(43) Pub. Date: Jan. 14, 2010

(54) IRREVERSIBLE TRANSMISSION DEVICE

(75) Inventors: Ghaffar Kazkaz, Rolling Meadows, IL (US); Didier Richard, Marignier (FR)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ITW SMPI, Cluses (FR)

(21) Appl. No.: 12/523,542

(22) PCT Filed: Feb. 5, 2008
(86) PCT No.: PCT/US2008/052981

§ 371 Date: Jul. 17, 2009

(30) Foreign Application Priority Data
Feb. 7, 2007 (FR) 07/00868

(51) Int. Cl. F16H 1/18

(52) U.S. Cl. 74/424.5

(57) ABSTRACT

The invention relates to a geared, irreversible motion transmitting device comprising a massive casing supporting an input means and an output means, one end of the input means being fitted with a pinion whereas one end of the output means is fitted with a gear wheel, said pinion and said gear wheel constituting a gear system. Said gearwheel and pinion are designed in a manner that, in operation, pinion rotation generates an effective force acting a distance off the center (C₂) of the gear wheel, thereby implementing a corresponding gear wheel rotation, whereas gear wheel rotation generates an effective force (F′₂) acting near the pinion center in a way to avert generating a corresponding pinion rotation.

The present invention relates to an irreversible geared motion transmitting device, further to electrical apparatus fitted with at least one such transmission device, and also to a motor vehicle fitted with at least one such electric apparatus.

Such transmission devices are used in different electrical apparatus, in particular those used in motor vehicles.

In such applications said electrical apparatus illustratively are in the form of a window drive, a seat moving drive, or also a windshield wiper. When integrated into an electric window drive, such transmission device is situated between an electric motor and a control driving the window pane.

The present invention also applies to electrical apparatus used outside the automotive industry. Illustratively these are window-blind drives, electrical household appliances, also portable electric tools.

Conventionally a geared motion transmitting device comprises two toothed elements, namely a gear wheel and a pinion. In general the gear wheel comprises more teeth than the pinion.

Typically a gear system transmits motion in both directions, i.e. reversibly. In other words, rotating one of the toothed elements, whether gear wheel or pinion, causes a related rotation of the other, namely the gear wheel or the pinion. This reversibility exists regardless of the direction of rotation and regardless of the friction between the teeth.

It is the object of the present invention to create a device allowing irreversible transmission of the motions between a drive means, or input means and a driven means, or output means. It follows that rotating the input means generates a corresponding motion of the output means whereas, when the output means is being rotated, the input means does not rotate significantly. Such irreversibility cannot be provided by the gear systems of the state of the art.

In order to design such an irreversible transmission device, it is known to use a worm cooperating with a tangent gear wheel of which the teeth are fitted in its rim. Such a speed reducer is irreversible if the worm's helical thread angle is less than the friction angle between the toothings. In this design, if the worm is driving, i.e. if it is the input means, the gear wheel shall rotate, whereas, if the gear wheel is driving, the worm will not rotate.

However this known design does entail some drawbacks which in particular relate to the low efficiencies of the gearing involved. Accordingly this design requires powerful motors which are expensive per se and operate at high energy costs.

Moreover the worm is a machined workpiece, hence costly. Also the axial stress at the end of the work is high, entailing high quality and hence expensive, axial stops

Therefore it is the object of the present invention to create a geared motion transmission device which is both irreversible and allows bypassing the above cited drawbacks inherent in a worm/ gear-wheel systems.

The objective of the present invention therefore is a geared motion transmission means comprising a casing which supports an input shaft and an output shaft, one end of the input shaft being fitted with a pinion whereas one end of the output shaft is fitted with a gear wheel, said pinion and gear wheel constituting a gear unit that is characterized in that said gear wheel and pinion are designed appropriately so that, during operation, rotating the pinion will generate an effective force both passing a distance from the gear-wheel center and commensurately rotating this gear wheel, whereas rotating the gear wheel applies a force to the pinion near its center and thereby fails to commensurately rotate this pinion.

The present invention comprises further features:
the ratio of the outside pinion diameter to the base pinion diameter is larger than 6, preferably larger than 10,
the ratio of the outside gear wheel diameter to the base gear wheel diameter is less than 4, preferably less than 3,
the pinion comprises one or two teeth,
the number of gear wheel teeth is larger than 15, preferably larger than 20,
the common transverse pressure angle of gear wheel and pinion is larger than 45°, preferably larger than 60°,
the profile shift coefficient of the pinion is larger than (+1+, preferably larger than (+2),
the profile shift coefficient of the gear wheel is less than (−1), preferably less than (−2).

Another object of the present invention is electrical apparatus, in particular a car window drive, a car seat moving device drive or a windshield wiper, characterized in that this apparatus is fitted with at least one geared irreversible motion transmission device such as defined above.

Lastly another object of the present invention is a motor vehicle fitted with at least one electrical apparatus as defined above.

The invention is elucidated below in relation to the appended drawings which are strictly illustrative, not limiting:

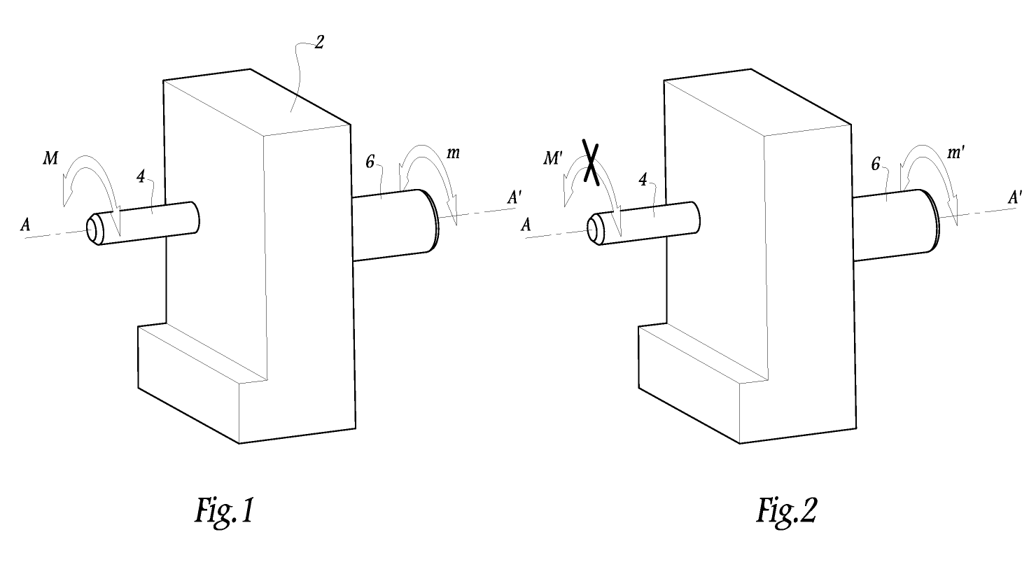

FIGS. 1, 2 are schematic views of a transmission device of the invention in two different positions,

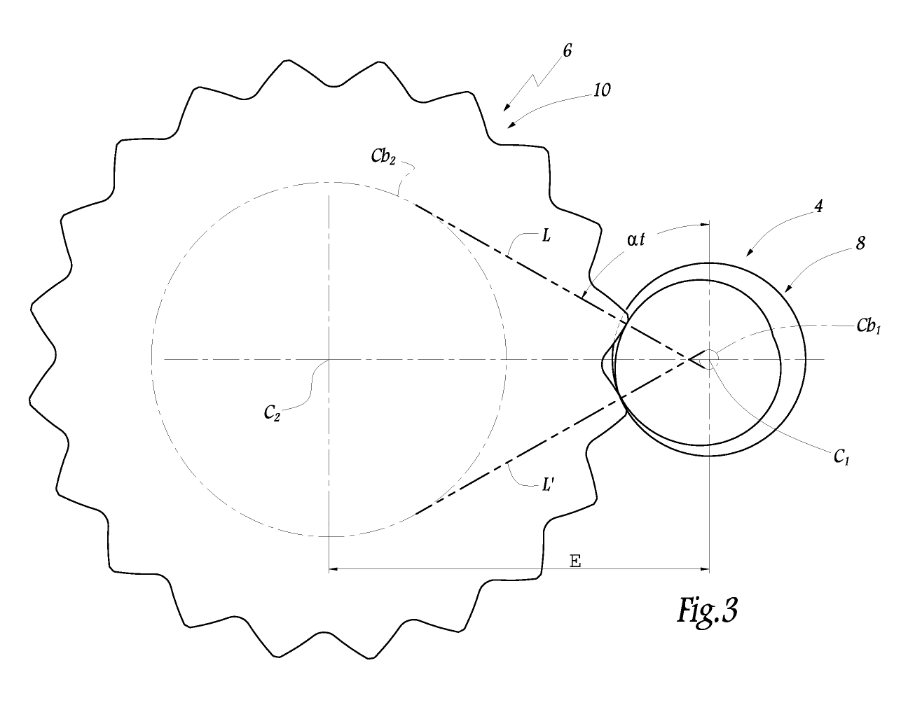

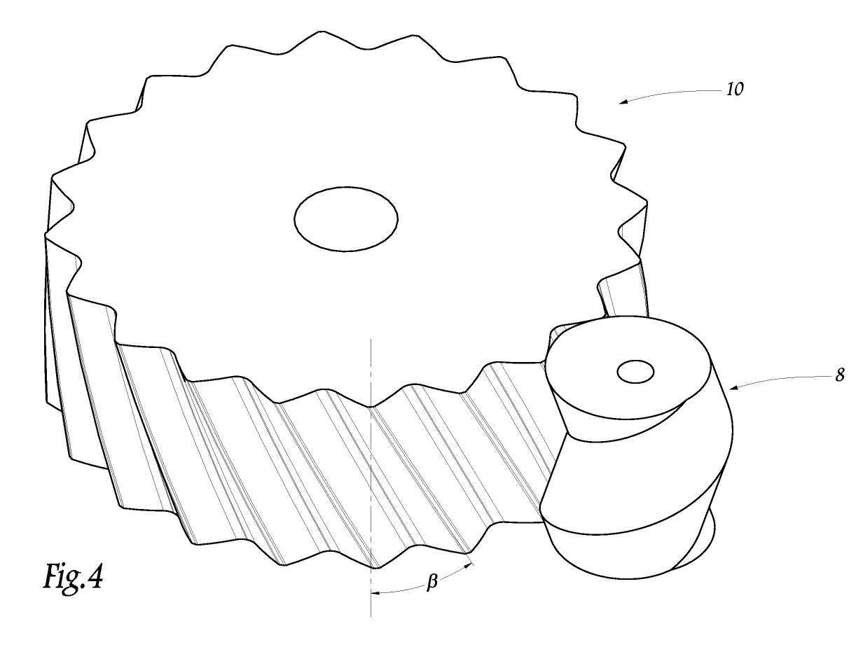

FIGS. 3, 4 are respectively a front view and a perspective which illustrate a gear system of the transmission device of the invention,

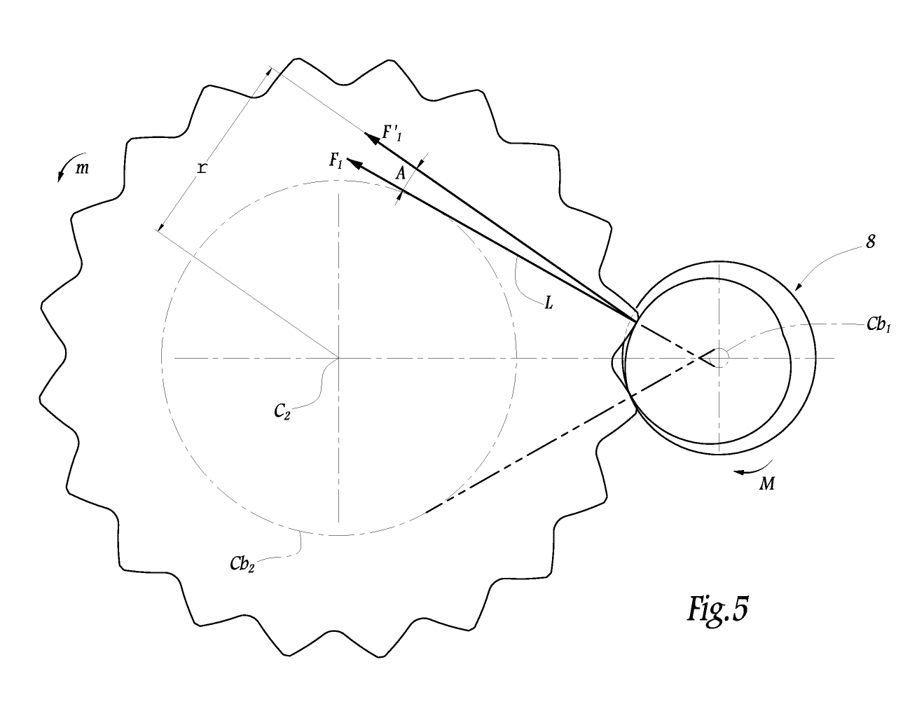

FIG. 5 is a front view similar to FIG. 3 and illustrates the pinion rotating the gear wheel of the pinion-and-gearwheel system,

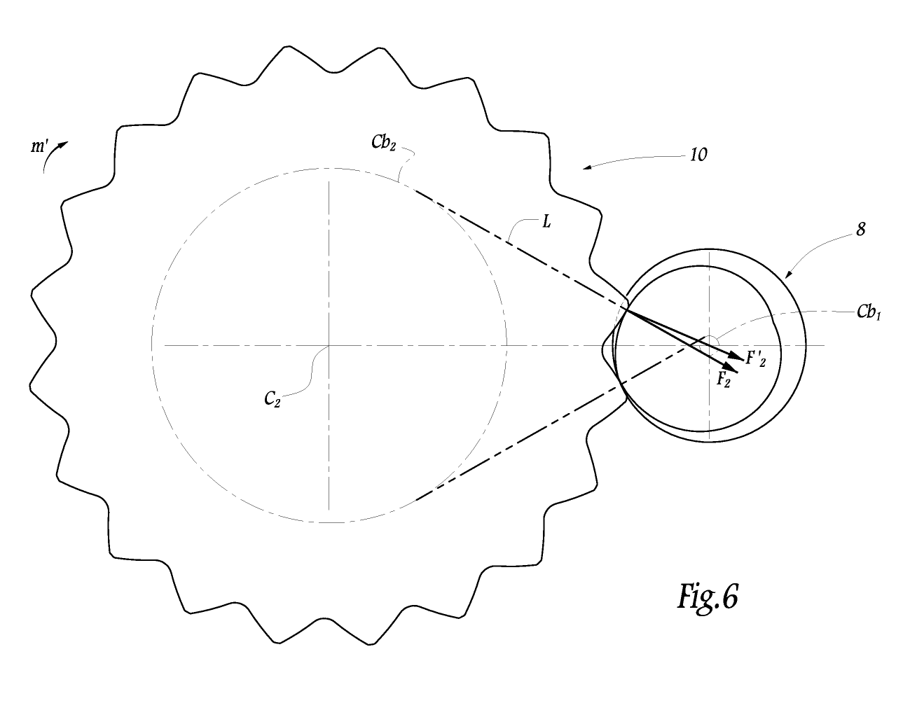

FIG. 6 is a front view similar to FIG. 3 illustrating locking the pinion when the gear wheel is rotated, and

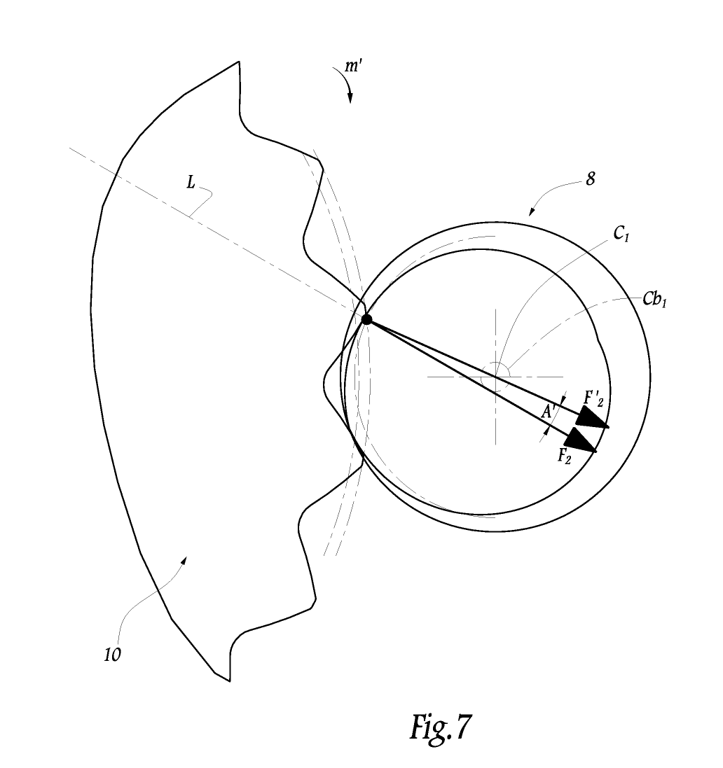

FIG. 7 is a view on a larger scale of FIG. 6.

The transmission device of the invention schematically shown in FIGS. 1 and 2 is used for instance in a car's window drive. However it may be integrated into other kinds of electrical apparatus, for motor vehicles or other applications.

This device comprises a massive, stationary casing 2 supporting an input shaft 4 and an output shaft 6. Motions are transmitted between these two shafts 4 and 6 by a gear unit inside said casing 2 and therefore not visible in these FIGS. 1 and 2, the said unit shall be elucidated below in relation to the following Figures.

The input shaft 4 is driven by a conventional rotating motor omitted from the Figures whereas the output shaft 6 is rigidly joined to a control means of the body to be displaced, illustrative a car's window drive. In the illustration of FIGS. 1 and 2, the shafts 4 and 6 subtend axes A and A′ respectively which are both parallel to and distinct from each other.

This transmission device of the invention is irreversible. As shown in FIG. 1, when the input shaft 4 is rotating in either direction, as indicated by the arrow M, the output shaft 6 also will be driven into rotation along the double arrow m. On the other hand, as shown in FIG. 2, when the output shaft is driven into rotation m′, any resultant rotation of the input shaft 4 is insignificant as indicated by the crossed-out double arrow M′.

In FIG. 3, the ends of the shafts 4 and 6 that may engage each other are respectively fitted with a pinion 8 and a gear wheel 10 that together constitute a gear unit. Said pinion and gear wheel bear outer cylindrical teeth designed with a contour forming a circular involute as used most widely in gear technology.

The different geometric features of said gear wheel and pinion are discussed below in illustrative and non-limiting manner:

Let C₁ and C₂ respectively be the center of the pinion 8 and the center of the gear wheel 10, situated on the axes A and A′, then the center distance E between these axes will be 18.37 mm. Also the transverse modulus relating to the pinion 8 and to the gear wheel 10 is mt=1.75.

As shown in further detail in FIG. 4, sad gear wheel and pinion are fitted with a helical toothing having a helix angle β=30°. The common transverse pressure angle of said gear wheel and pinion is αt=60° (FIG. 3).

Moreover the pinion 8 comprises:
a number of teeth Z₁=1.
an profile shift coefficient x₁=+2,
an outside diameter da₁=9.34 mm,
a root diameter df₁=6.58 mm and
a base diameter db₁=0.87 mm.

The formula for the base diameter is given by

db=mt.Z.cos(αt).

Moreover the gear wheel 10 comprises:
a number of teeth Z₂=20,
an profile shift x₂=−2,
an outside diameter da₂=29.2 mm,
a root diameter df₂=26.4 mm and
a base diameter db₂=17.50 mm.

The action lines L and L′ are shown in FIG. 3 and are known per se to be the tangents to the two base circles Cb₁ and Cb₂ having the above defined base diameters. As shown in FIG. 5, when the pinion 8 is rotating in the direction of the arrow M, a theoretical force F₁ is generated along the line of action L in the idealized frictionless case. If a friction-caused angle A is assumed, the actual force F′₁, is situated offset by the same angle from the line of action.

Be it borne in mind that in the above scenario, the offset of the actual force from the line of action L is generated by deviating from the gear wheel axis because the friction opposes the motion between the two surfaces making contact with each other, whereas the meshing takes place in a recess contact zone of the toothings. The concept of a gear recess and that of gear approach has been treated for instance in G. Henriot's “Traité théorique et pratique des engrenages” [Theory and Practice of Gears], Dunod. publishers. Under these conditions the torque applied by the pinion is given by C₁=|F′₁|*r, where |F′₁| is the magnitude of the force F′₁.

Consequently regardless of friction magnitude, the gear wheel is subjected to a positive torque generating the rotation in the direction of the arrow m.

When the gear wheel 10 is rotated in the direction of the arrow m′ as shown in FIGS. 6 and 7, a theoretical force F₂ in the direction of the line of action L. However if friction causing an offset angle A′ is taken into account, there will be a corresponding force offset along this same angle A′.

Be it borne in mind that contrary to discussion above relating the forces F₁ and F′₁, the offset of the force F₂ occurs while moving closer to the pinion axis: the friction opposes the motion between the two contact surfaces whereas meshing henceforth takes place exclusively in the toothings' approaching zone.

Under these conditions, if the friction angle is large enough, the effective force F′₂ passes through the pinion center C₁, even at the opposite side of said center relative to the line of action.

In that case the rotational torque is zero when the force passes through the center or else negative if on the other side of the center. As a result, the gear system jams and becomes irreversible.

As discussed above, such irreversibility is attained in the invention by offsetting the effective force F′₂ toward the pinion center to cancel or even make negative the corresponding torque.

In this light it is advantageous that the ratio R₁ of the outside diameter da₁ to the base diameter db₁ of the pinion 8 be especially high. Illustratively this ratio R₁ is larger than 6, preferably larger than 10.

Consequently it is also advantageous on the other hand that the ratio R₂ of the outside diameter da₂ to the base diameter db₂ of the gear wheel shall be relatively small. Illustratively said ratio R₂ shall be less than 4 and preferably less than 3.

Also advantageously the number of teeth Z₁ of the pinion 8 is very small, for instance being 1 or 2 teeth.

Again it is equally advantageous in this respect that the number of teeth Z₂ of the gear wheel 10 be comparatively large, for instance larger than 15, and preferably larger than 20.

Moreover the pressure angle αt common to the pinion 8 and the gear wheel 10 advantageously shall be large, for instance being more than 45, preferably more than 60°.

Again the profile shift coefficient x₁ of the pinion 8 advantageously shall be positive and large, for instance being larger than +1, preferably larger than +2.

Again in this light, the profile shift coefficient x₂ of the gear wheel 10 on the other hand advantageously shall be negative while its absolute value is high, whereby this profile shift coefficient illustratively shall be smaller than −1, preferably smaller than −2.

The present invention meets the above cited objectives:

The irreversible gear system of the present invention offers higher efficiency than those of the state of the art. Be it noted in this respect that an irreversible reducer making use of a gear wheel and a worm offers an efficiency at most 30% approximately. An irreversible reducer using an epicyclical power train offers a maximum efficiency of about 20%.

On the other hand, a substantial gain in efficiency is offered by the present invention relative to the known designs.

Be it also borne in mind that the gear system of the invention can be manufactured in comparatively simple manner using standard tool means. Its teeth may be made by conventional shaping. The gear system of the present invention also may be manufactured in many different materials, for instance in plastics, by powder sintering, or other ways.

The solution/design of the present invention is applicable to different kinds of gear systems. Without implying restriction, among these are the cylindrical helical gear systems having parallel axes and also helical gear systems with pinion and rack. In the latter case, the rack is construed being a gear wheel with an infinite number of teeth.

1. An irreversible motion transmitting gear device comprising a casing supporting an input means and an output means, one end of the input means being fitted with a pinion whereas one end of the output means is fitted with a gear wheel, said pinion and said gear wheel constituting a gear system,
characterized
in that said gear wheel and pinion are designed in a manner that in operation the pinion rotation generates an effective force (F′₁) transmitted along a path a distance away from the gear wheel center (C₂) in order to correspondingly rotate said gear wheel, whereas gear wheel rotation generates an effective force (F′₂) situated near the pinion center (C₁) in a way not to generate a corresponding pinion rotation.

2. Device as claimed in claim 1, characterized in that the ratio (R₁) of the outside diameter (da₁) to the base diameter (db₁) of the pinion is larger than 6, preferably larger than 10.

3. Device as claimed in claim 1, characterized in that the ratio (R₂) of the outside diameter (da₂) to the base diameter (db₂) of the gear wheel is less than 4, preferably less than 3.

4. Device as claimed in claim 1, characterized in that the number of teeth (Z₁) of the pinion is 1 or 2.

5. Device as claimed in claim 1, characterized in that the number of teeth (Z₂) of the gear wheel is larger than 15, preferably larger than 20.

6. Device as claimed in claim 1, characterized in that the transverse pressure angle (αt) common to the gear wheel and the pinion (8) is larger than 45, preferably larger than 60°.

7. Device as claimed in claim 1, characterized in that the pinion has an profile shift coefficient (x₁) larger than (+1), preferably larger than (+2).

8. Device as claimed in claim 1, characterized in that the profile shift coefficient (x₂) of the gear wheel is less than (−1), preferably less than (−2).

9. Electrical apparatus, in particular a window drive, a seat displacement drive or a windshield wiper, characterized by comprising at least one geared irreversible motion transmitting device claimed in claim 1.

10. Motor vehicle comprising at least one electrical apparatus defined in claim 1.
